(19) United States
(12) Patent Application Publication
(10) Pub. No.: US 2026/0023595 A1
(43) Pub. Date: Jan. 22, 2026

(54) REQUEST BATCH PROCESSING FOR MACHINE LEARNING MODELS

(71) Applicant: Dell Products L.P., Round Rock, TX (US)

(72) Inventors: Pedro Fernandez Orellana, Surfers Paradise (AU); Qiang Chen, Shanghai (CN)

(21) Appl. No.: 18/779,370

(22) Filed: Jul. 22, 2024

(51) Int. Cl. G06F 9/48

(52) U.S. Cl. CPC G06F 9/4881

(57) ABSTRACT

An apparatus comprises at least one processing device configured to execute, in a first batch, a set of requests utilizing at least one machine learning model, to determine, during execution of the first batch, whether any request drop activation conditions are triggered and to establish a request drop threshold responsive to determining that at least one request drop activation condition has been triggered. The at least one processing device is also configured to determine whether any of the requests are still executing when the request drop threshold is reached, to stop execution of the first batch responsive to determining that at least a subset of the first set of requests are still executing when the request drop threshold is reached, and to execute at least one request in the subset of the first set of requests in a second batch utilizing the at least one machine learning model.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Large language models (LLMs) are a type of AI system that uses ML algorithms to process vast amounts of natural language text data. LLMs may be used to perform various natural language processing (NLP) tasks, including text classification, text summarization, text generation, named entity recognition, text sentiment analysis, and question answering.

### SUMMARY

Illustrative embodiments of the present disclosure provide techniques for request batch processing for machine learning models.

In one embodiment, an apparatus comprises at least one processing device comprising a processor coupled to a memory. The at least one processing device is configured to execute, in a first batch, a first set of requests utilizing at least one machine learning model, to determine, during execution of the first batch, whether one or more request drop activation conditions are triggered, and, responsive to determining that at least one of the one or more request drop activation conditions has been triggered, to establish a request drop threshold for stopping execution of the first batch. The at least one processing device is also configured to determine whether any of the requests in the first set of requests are still executing when the request drop threshold is reached, responsive to determining that at least a subset of the first set of requests are still executing when the request drop threshold is reached, to stop execution of the first batch, and to execute, in a second batch, a second set of requests utilizing the at least one machine learning model, the second set of requests including at least one request in the subset of the first set of requests.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for request batch processing for machine learning models in an illustrative embodiment.

FIG. 2 is a flow diagram of an exemplary process for request batch processing for machine learning models in an illustrative embodiment.

FIG. 3 shows a batch timeline for processing a batch of inference requests using a machine learning model in an illustrative embodiment.

FIG. 4 shows prefilling and decoding stages of inference processing using a decoder-based transformers machine learning model architecture in an illustrative embodiment.

FIG. 5 shows differences in runtime, computation and bandwidth requirements for processing different numbers of tokens in prefilling and decoding stages of inference processing for a machine learning model in an illustrative embodiment.

FIG. 6 shows batch processing of requests including different amounts of prefilling and decoding operations of inference processing for a machine learning model in an illustrative embodiment.

FIG. 7 shows padding strategies for alignment of requests in inference processing for a machine learning model in an illustrative embodiment.

FIG. 8 shows a batch execution flow of requests in inference processing for a machine learning model that utilizes a greedy request drop threshold in an illustrative embodiment.

FIG. 9 shows an example of execution of a set of requests in inference processing for a machine learning model with and without use of greedy request drop functionality in an illustrative embodiment.

FIG. 10 shows another example of execution of a set of requests in inference processing for a machine learning model with and without use of greedy request drop functionality in an illustrative embodiment.

FIG. 11 shows a system flow for asymmetric pad-less caching in inference processing for a machine learning model in an illustrative embodiment.

FIG. 12 shows examples of symmetric and asymmetric key-value caches used in inference processing for a machine learning model in an illustrative embodiment.

FIG. 13 shows a process flow for re-queuing a request in inference processing for a machine learning model using a greedy request drop threshold in an illustrative embodiment.

FIG. 14 shows a process flow for implementing greedy request drop functionality in inference processing for a machine learning model in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

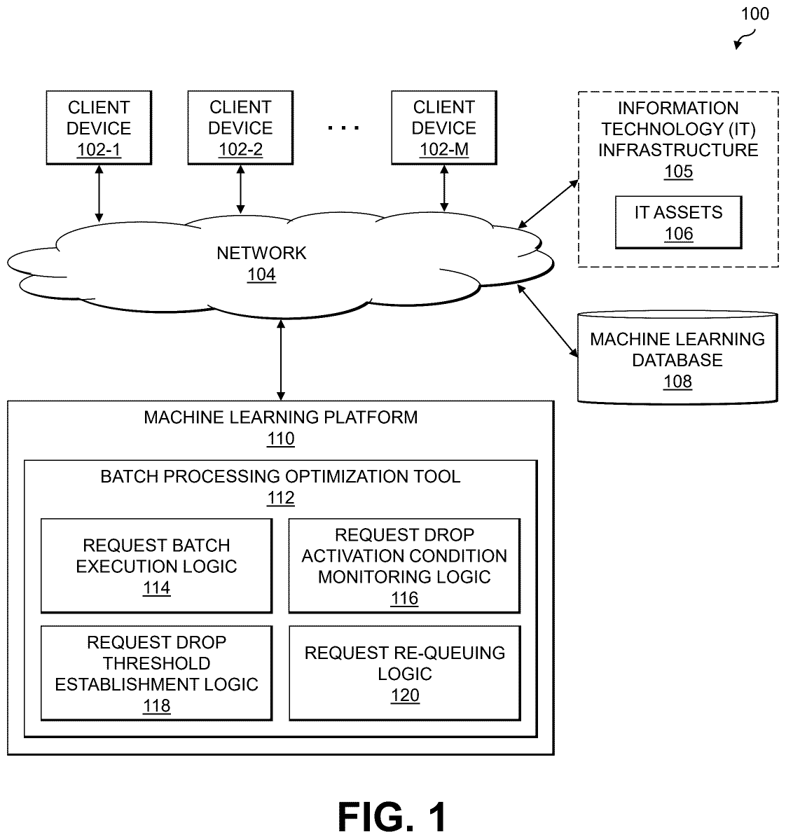

FIG. 1 shows an information processing system 100 configured in accordance with an illustrative embodiment. The information processing system 100 is assumed to be built on at least one processing platform and provides functionality for request batch processing for machine learning models. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a machine learning database 108, and a machine learning platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the machine learning platform 110 is used for an enterprise system. For example, an enterprise may subscribe to or otherwise utilize the machine learning platform 110 for processing of requests utilizing one or more machine learning models. The one or more machine learning models may comprise natural language processing (NLP) models such as large language models (LLMs). The requests may comprise, by way of example, input prompts that are to be processed using the LLMs. Each of the input prompts may comprise natural language text, with the LLMs processing those input prompts to output responses which also comprise natural language text. It should be appreciated, however, that various other types of requests (e.g., requests which do not include natural language text) may be processed depending on the type or configuration of the one or more machine learning models. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The machine learning database 108 is configured to store and record various information that is utilized by the machine learning platform 110. Such information may include, for example, user prompts (e.g., text-based, voice or audio-based using speech-to-text conversion, etc.), model parameters and configuration for one or more machine learning models (e.g., one or more LLMs), caches of inputs and outputs for one or more requests being processed using one or more machine learning models, etc. The machine learning database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the machine learning platform 110, as well as to support communication between the machine learning platform 110 and other related systems and devices not explicitly shown.

The machine learning platform 110 may be provided as a cloud service that is accessible by one or more of the client devices 102 to allow users thereof to generate requests that are processed using one or more machine learning models. In some embodiments, the client devices 102 are assumed to be associated with users of an enterprise, organization or other entity that seek to utilize one or more machine learning models (e.g., LLMs). In some embodiments, the client devices 102 are utilized by members of the same enterprise, organization or other entity that operates the machine learning platform 110. In other embodiments, the client devices 102 are utilized by members of one or more enterprises, organizations or other entities different than the enterprise, organization or other entity that operates the machine learning platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the machine learning database 108 and the machine learning platform 110 regarding input prompts to one or more machine learning models (e.g., one or more LLMs) and output responses for such input prompts generated by the one or more machine learning models. It should be noted that a “host agent” as this term is generally used herein may comprise an automated entity, such as a software entity running on a processing device. Accordingly, a host agent need not be a human entity.

The machine learning platform 110 in the FIG. 1 embodiment is assumed to be implemented using at least one processing device. Each such processing device generally comprises at least one processor and an associated memory, and implements one or more functional modules or logic for controlling certain features of the machine learning platform 110. In the FIG. 1 embodiment, the machine learning platform 110 implements a batch processing optimization tool 112. The batch processing optimization tool 112 comprises request batch execution logic 114, request drop activation condition monitoring logic 116, request drop threshold establishment logic 118, and request re-queuing logic 120. The request batch execution logic 114 is configured to group requests in batches to be processed utilizing at least one machine learning model (e.g., an LLM), and to execute such requests batches. The request drop activation condition monitoring logic 116 is configured to monitor for one or more request drop activation conditions during execution of the batches of requests. Responsive to detecting one of the request drop activation conditions during execution of a given batch, the request drop activation condition monitoring logic 116 triggers the request drop threshold establishment logic 118 to establish a request drop threshold for the given batch (e.g., a specified time, number of output tokens, etc.). The request re-queuing logic 120 is configured to detect when the given batch reaches the established request drop threshold. If any requests of the given batch are still executing when the established request drop threshold is reached, the request re-queuing logic 120 will stop execution of the given batch and re-queue any of the requests that are still executing into another batch.

At least portions of the batch processing optimization tool 112, the request batch execution logic 114, the request drop activation condition monitoring logic 116, the request drop threshold establishment logic 118, and the request re-queuing logic 120 may be implemented at least in part in the form of software that is stored in memory and executed by a processor.

It is to be appreciated that the particular arrangement of the client devices 102, the IT infrastructure 105, the machine learning database 108 and the machine learning platform 110 illustrated in the FIG. 1 embodiment is presented by way of example only, and alternative arrangements can be used in other embodiments. As discussed above, for example, the machine learning platform 110 (or portions of components thereof, such as one or more of the batch processing optimization tool 112, the request batch execution logic 114, the request drop activation condition monitoring logic 116, the request drop threshold establishment logic 118, and the request re-queuing logic 120) may in some embodiments be implemented internal to the IT infrastructure 105.

The machine learning platform 110 and other portions of the information processing system 100, as will be described in further detail below, may be part of cloud infrastructure.

The machine learning platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the machine learning database 108 and the machine learning platform 110 or components thereof (e.g., the batch processing optimization tool 112, the request batch execution logic 114, the request drop activation condition monitoring logic 116, the request drop threshold establishment logic 118, and the request re-queuing logic 120) may be implemented on respective distinct processing platforms, although numerous other arrangements are possible. For example, in some embodiments at least portions of the machine learning platform 110 and one or more of the client devices 102, the IT infrastructure 105, the IT assets 106 and/or the machine learning database 108 are implemented on the same processing platform. A given client device (e.g., 102-1) can therefore be implemented at least in part within at least one processing platform that implements at least a portion of the machine learning platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the machine learning database 108 and the machine learning platform 110, or portions or components thereof, to reside in different data centers. Numerous other distributed implementations are possible. The machine learning platform 110 can also be implemented in a distributed manner across multiple data centers.

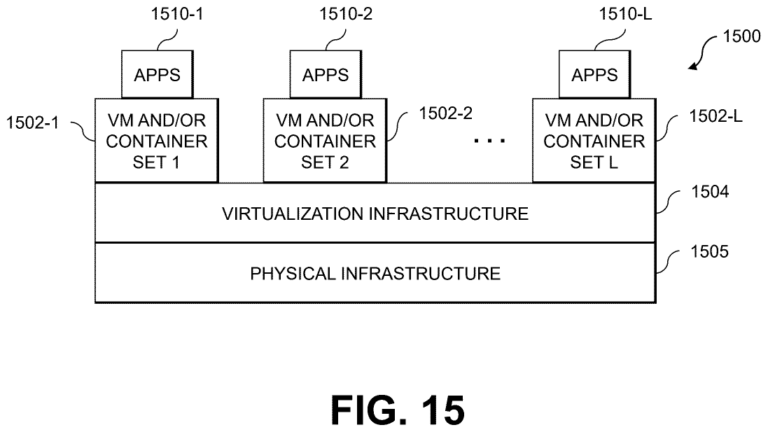

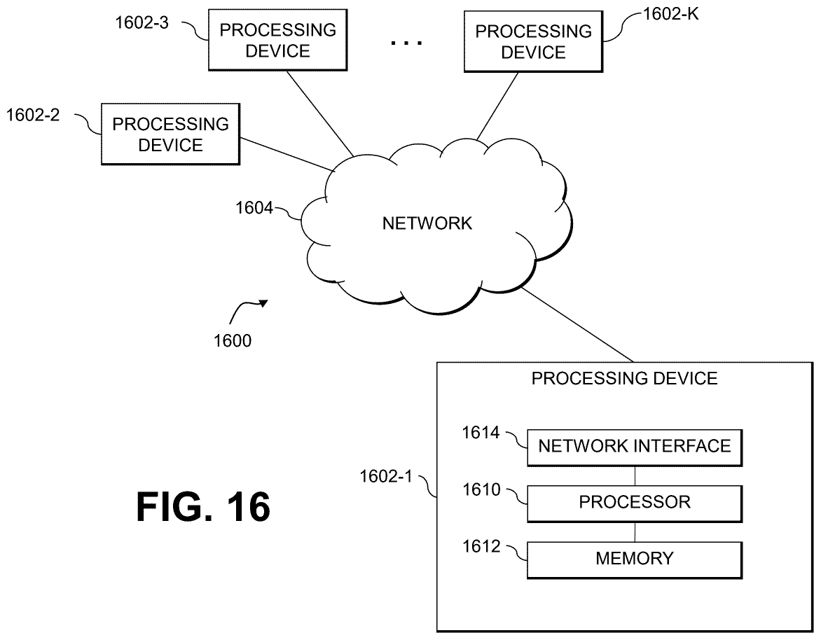

Additional examples of processing platforms utilized to implement the machine learning platform 110 and other components of the information processing system 100 in illustrative embodiments will be described in more detail below in conjunction with FIGS. 15 and 16.

It is to be understood that the particular set of elements shown in FIG. 1 for request batch processing for machine learning models is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

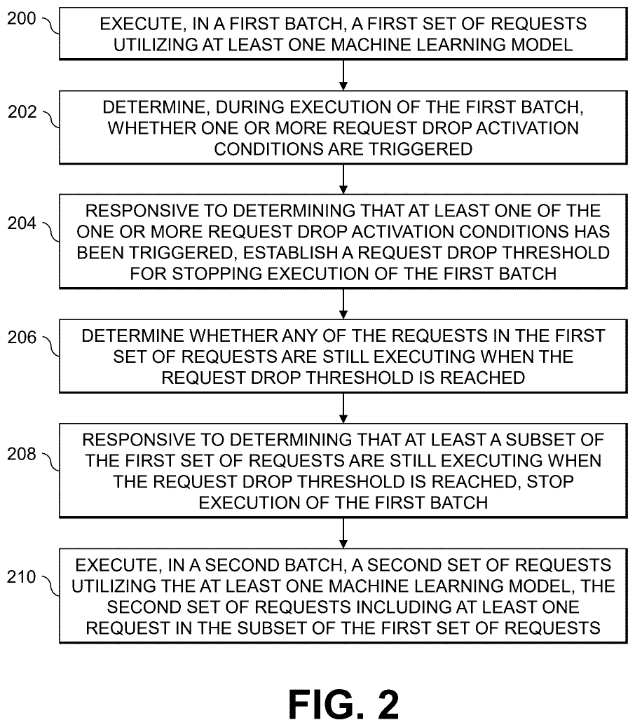

An exemplary process for request batch processing for machine learning models will now be described in more detail with reference to the flow diagram of FIG. 2. It is to be understood that this particular process is only an example, and that additional or alternative processes for request batch processing for machine learning models may be used in other embodiments.

In this embodiment, the process includes steps 200 through 210. These steps are assumed to be performed by the machine learning platform 110 utilizing the batch processing optimization tool 112, the request batch execution logic 114, the request drop activation condition monitoring logic 116, the request drop threshold establishment logic 118, and the request re-queuing logic 120. The process begins with step 200, executing, in a first batch, a first set of requests utilizing at least one machine learning model. The at least one machine learning model may comprise a large language model (LLM), and the first set of requests may be for processing input prompts to the LLM to generate output responses. Step 200 may include allocating a portion of memory for a symmetrical cache for maintaining input and output tokens generated as part of processing the first set of requests, the symmetrical cache having a size determined based at least in part on a number of requests in the first set of requests, a maximum sequence length for the first set of requests, and a number of hidden layers of the at least one machine learning model. Step 200 may alternatively include allocating a portion of memory for an asymmetrical cache for maintaining input and output tokens generated as part of processing the first set of requests, the asymmetrical cache having a size determined based at least in part on a number of requests in the first set of requests, sequence lengths of different ones of the requests in the first set of requests, and a number of hidden layers of the at least one machine learning model.

In step 202, during execution of the first patch, a determination is made as to whether one or more request drop activation conditions are triggered. The one or more request drop activation conditions may comprise determining that at least a threshold number of requests in the first set of requests has finished execution. The threshold number may comprise a designated percentage of a total number of requests in the first set of requests. The one or more request drop activation conditions may be based at least in part on a number of requests waiting to be executed utilizing the at least one machine learning model.

Responsive to determining that at least one of the one or more request drop activation conditions has been triggered, a request drop threshold for stopping execution of the first batch is established in step 204. The request drop threshold may comprise a specified period of time, a specified number of output tokens generated utilizing the at least one machine learning model, etc. The request drop threshold, in some embodiments, specifies a static upper limit for execution time of requests in the first set of requests. The request drop threshold, in other embodiments, specifies a dynamic upper limit for execution time of requests in the first set of requests that is based at least in part on an execution time for completed requests in the first set of requests.

In step 206, a determination is made as to whether any of the requests in the first set of requests are still executing when the request drop threshold is reached. Responsive to determining that at least a subset of the first set of requests are still executing when the request drop threshold is reached, execution of the first batch is stopped in step 208. In step 210, a second set of requests is executed, in a second batch, utilizing the at least one machine learning model. The second set of requests includes at least one request in the subset of the first set of requests (whose execution was stopped in step 208). Executing the at least one request in the subset of the first set of requests in the second batch may start from a last output token generated during execution of the at least one request during the first batch.

In some embodiments, each of the requests in the first set of requests comprises a prefilling stage where an input prompt is tokenized and processed to fill activation tensors of one or more layers of the machine learning model and a decoding stage where in each pass a new token is generated and appended to the input prompt for processing in a next pass. Stopping execution of the subset of the first set of requests in step 208 may comprise, for at least one request in the subset of the first set of requests, concatenating the new tokens generated in the decoding stage with the tokenized input prompt to generate an updated tokenized input prompt and executing the at least one request in the subset of the first set of requests in the second batch in step 210 utilizes the updated tokenized input prompt in the prefilling stage.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Large language models (LLMs) may be used for a wide variety of tasks. LLMs may be implemented using decoder-based transformer architectures. Such decoder-based transformer architectures, as well as other model architectures, may be bottlenecked by memory capacity and bandwidth. For example, inference for decoder-based transformer architectures may have a graphical processing unit (GPU) utilization of less than 2% (e.g., floating-point operations per second (FLOPs) utilization). A key-value (KV) cache is an important component in decoder-based transformer architectures that reduces computation needed at the expense of increasing memory requirements. The extra memory allocated for the KV cache may result in over-allocation of resources as, due to the uncertainty on the length of the response of an LLM, it is not possible to compute beforehand how much memory (and thus, how large of a KV cache) will be required for a specific request (e.g., beyond setting an upper limit). This issue is compounded when batching is applied. In the Generative Pre-Trained Transformer (GPT) family of LLMs, for example, the KV cache is responsible for a large portion of the total memory required. This adds to the issue that LLMs are heavily bottlenecked by memory, making compute hardware resources heavily underutilized.

Batching provides a way to improve resource utilization (e.g., compute hardware utilization) for LLMs, and for artificial intelligence (AI) and machine learning (ML) models generally. By batching requests on inference, parallelization of hardware is exploited to increase utilization. For example, the compute hardware utilization for GPT LLMs generally decreases as sequence length increases and increases as batch size increases. Due to the memory requirements of LLMs, however, it is not common to have large batch sizes. Most LLMs, for example, use a batch size of 1 to 8.

Thus, as a general rule, to increase resource utilization (e.g., compute hardware utilization in a GPU-based system), it is desired to set the batch size for LLM inference as large as the memory capacity of the system allows. This will depend on the specific configuration and LLM parameters size, and is typically limited to the single-digit range. For example, a GPT-3 175B LLM with a sequence length of 1000 tokens may use 4 gigabytes (GB) of KV cache memory per request, so every increase in the batch size increases the memory required by 4 GB. The problem remains, however, that the KV cache is memory capacity intensive which limits the batch size and resource utilization that can be achieved. Further, the inherent uncertainty of the response size of an LLM inference operation provides additional technical challenges linked with both batching and the KV cache. Thus, even within a batch inference, compute and memory resources may be wasted due to the overall difference in sequence length of requests within a specific batch.

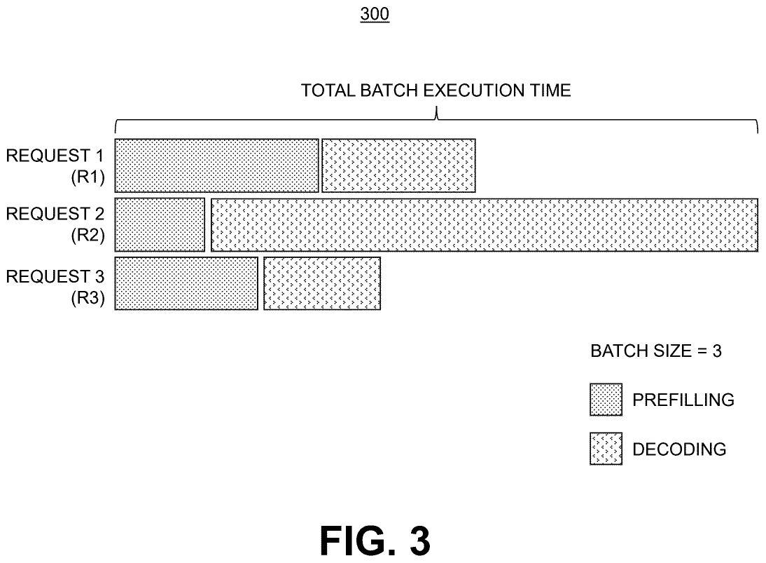

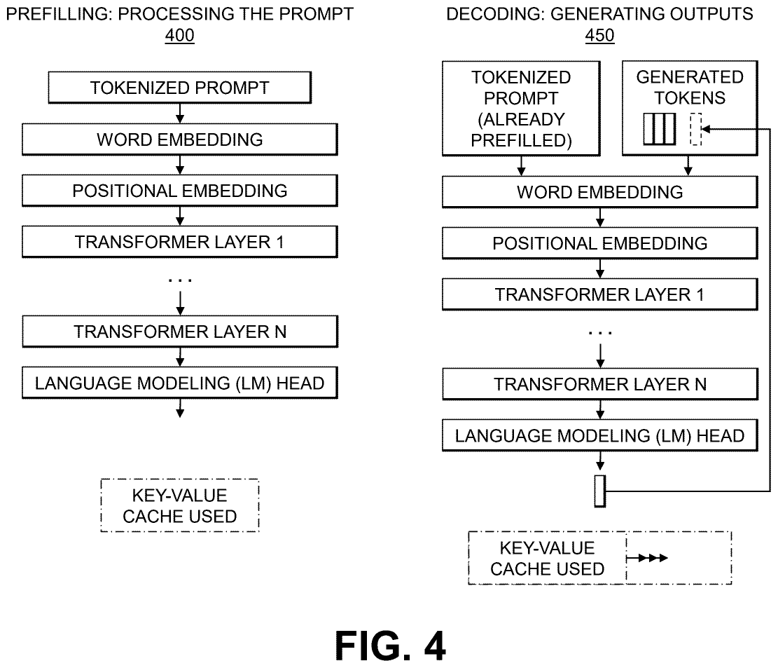

FIG. 3 shows a batch inference timeline 300 for a batch of size 3 including requests R1, R2 and R3. The total batch execution time is based on the longest executing one of the requests in the batch which, in the example of FIG. 3, is R2. Thus, R2 increases the overall batch execution time. Each of the requests R1, R2 and R3 includes a first input or “prefilling” portion and a second output or “decoding” portion. The prefilling and decoding portions of request processing will be described in further detail below with respect to FIG. 4. While R2 is still executing, R1 and R3 are idle. In some cases, R1 and R3 are still being executed although their content is ignored as they generate an “end of sequence” (<eos>) token or other identifier that defines the requests as completely generated. As R1 and R3 are still part of the same batch as R2, the decoding is still done upon the three entries on the batch. If R1 and R3 finish early (e.g., before R2), their results can be returned as soon as they finish (e.g., once they generate an <cos> token). This, however, is not the default setting for all systems (e.g., including the default HuggingFace generate function). Even if a system has “eager return” functionality (e.g., where the results of R1 and R3 are returned as soon as they finish rather than waiting until the entire batch is completed processing), there is still poor utilization as R2 is either processing alone, or R1 and R3 are processing nonsense values (e.g., because their results have already been returned).

Illustrative embodiments provide technical solutions for optimizing or improving hardware resource utilization during batch processing in AI/ML model inference (e.g., LLM inference) through implementation of greedy request drop (GRD) functionality. The technical solutions are thus able to reduce overall latency for AI/ML model inference and increase overall hardware resource (e.g., GPU) utilization. The GRD functionality allows for stopping and re-queuing of requests within a batch that are being overly “greedy” with their output sequence generation length (e.g., requests within a batch that are still decoding for a designated threshold period of time or number of output tokens, while other requests within the batch have already finished).

FIG. 4 illustrates decoder-based transformers execution for an LLM model, including a prefilling stage 400 and a decoding stage 450. The prefilling stage 400 is the stage where the input prompt is processed as a whole by the layers of the LLM model before reaching the output layer. The input prompt processing “fills” the activation tensors and keeps them in memory (e.g., a KV cache). The prefilling stage 400 is compute bound (e.g., as GPU or other compute hardware resources can be saturated). In the prefilling stage 400, the input prompt is tokenized, and all tokens in the tokenized prompt are processed at once on a single forward pass through the different layers, including word embedding, positional embedding, transformer layers 1 through N, and a language modeling (LM) head.

The decoding stage 450 is the stage where outputs are generated. Decoding refers to the autoregressive token generation process, where one new token is generated and appended to the prompt as input to the next step. Thus, the tokenized prompt (which is already prefilled as a result of the prefilling stage 400) and the generated tokens are passed through the different layers, including the word embedding, positional embedding, transformer layers 1 through N, and the LM head. In each forward pass through these layers, another token is generated and appended to the list of generated tokens that is used in the next pass through (along with the prefilled tokenized prompt). Thanks to the KV cache, the “prefilled” part does not need to be recomputed-only incremental computation is needed. The decoding stage 450 is thus memory bandwidth bound.

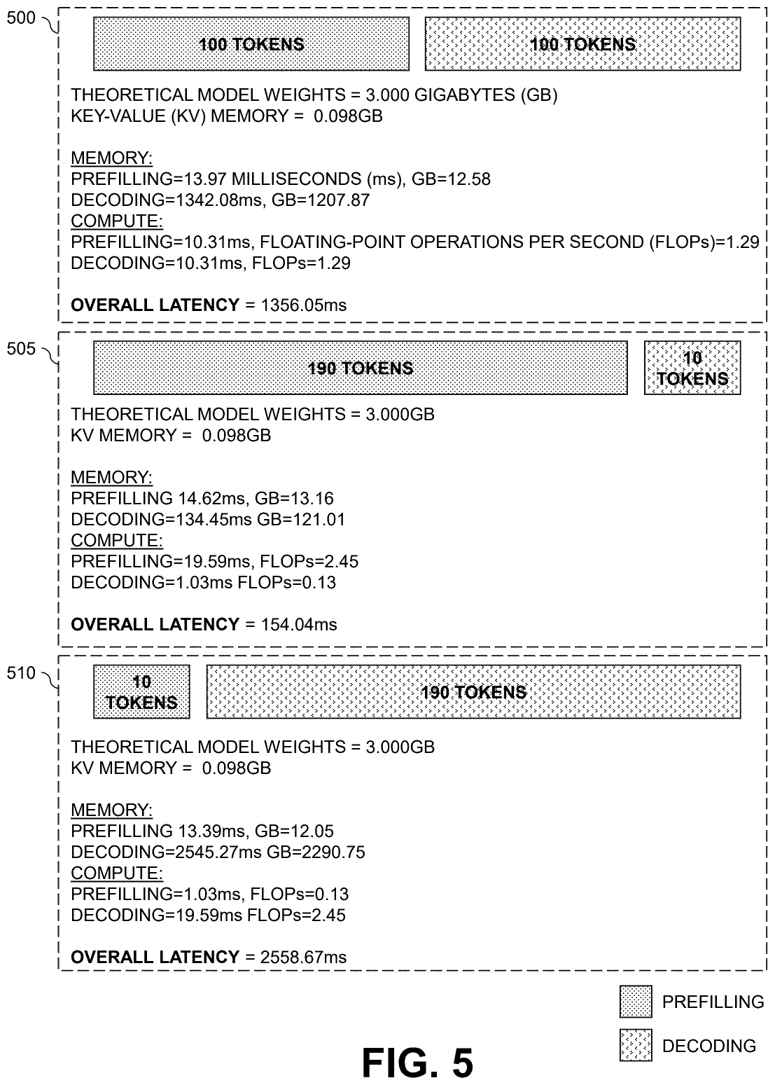

On hardware accelerators, such as GPUs, the decoding stage 450 tends to run several magnitudes slower than the prefilling stage 400, as the decoding stage 450 is heavily memory bounded in comparison with the prefilling stage 400 which is computationally bounded. This is a result of hardware accelerators having relatively high computation capabilities, but falling short in memory bandwidth and capacity in comparison with the resources needed to run the LLM inference. FIG. 5 shows the computing, bandwidth and runtime difference for the prefilling stage 400 and the decoding stage 450 for different examples 500, 505 and 510 including different numbers of prefilling and decoding token lengths. The example 500 includes a prefilling token length of 100 and a decoding token length of 100, with an overall latency of 1356.06 milliseconds (ms). The example 505 includes a prefilling token length of 190 and a decoding token length of 10, with an overall latency of 154.05 ms. The example 510 includes a prefilling token length of 10 and a decoding token length of 190, with an overall latency of 2558.67 ms.

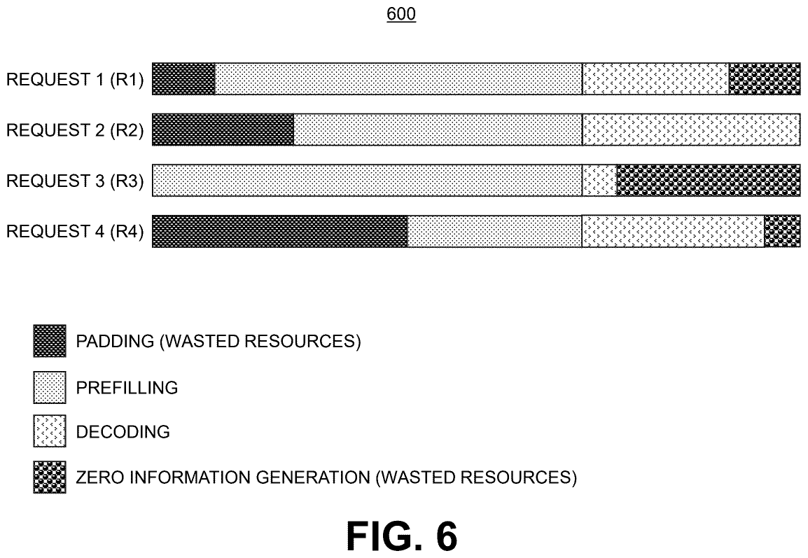

LLM inference processing thus relies on parameters including batch size and the expected maximum length for a response. Batching may be used in AI/ML to further improve hardware resource utilization by aggregating several requests and executing them in parallel. The static character of batching, however, does not fit properly with the un-deterministic character of LLMs. The technical challenges for batching LLM requests thus include: that batching requires uniformly shaped request input, while transformer requests are variable, which leads to the need for “padding” or zero-information filling; that transformer requests have variable endings, while batching has a uniform ending across requests (as even if requests are returned once they finish, the overall execution of the batch continues), which leads to the need to either keep processing requests within a batch until all the requests finish or performing zero-information generation; and that overall transformers computation and memory profile are asymmetric while batching is inherently symmetrical. FIG. 6 shows batch processing 600 of a set of four requests R1, R2, R3 and R4. Here, the prefilling and decoding of each of the requests R1, R2, R3 and R4 is “useful” hardware utilization, while padding (e.g., left padding in R1, R3 and R4) and zero-information generation (in R1, R3 and R4) leads to wasted resources.

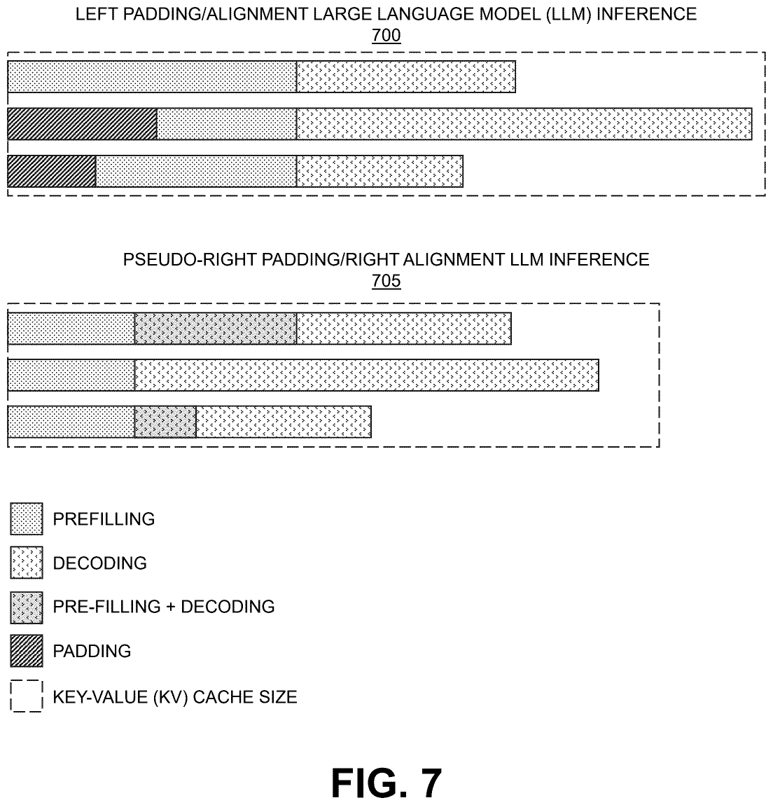

FIG. 7 shows padding strategies used for alignment in LLM inference processing, including left padding 700 and pseudo-right padding 705 approaches. In the left padding 700 approach, there is no significant overhead in computing but there is increased KV cache memory usage. In the pseudo-right padding 705 approach, there is advantageously no KV cache memory overhead, though there is more decoding computation as there are extra decoding steps determined according to the following equation: extra decoding steps=sum([input_{sequences}]−min(input_{sequences})). For the left padding approach 700, extra padding is added on the requests input, which increases the memory size (e.g., the size of the KV cache) and the bandwidth required for processing a batch.

Due to the nature of AI/ML models such as LLMs, the output token size cannot be computed beforehand (beyond limiting the maximum output size that an LLM can produce). This means that requests can output responses that vary in size and in computation time. Since the LLM inference/request output size cannot be computed beforehand, this leads to unpredictable computing time. Further, individual request execution time variability may impact batching performance. Traditional batch execution is ill-suited for LLM inference, as significant resources may be wasted due to the unpredictable difference on execution time and resources among the requests in a batch. Even if several requests within a batch being executed have finished and returned their results, the overall batch will keep executing until the last request in the batch has finished. This wastes resources by processing the data of the already-finished requests in the batch.

Illustrative embodiments provide technical solutions for advanced batching and execution orchestration for AI/ML model inference (e.g., LLM inference), which can advantageously greatly reduce overall batch execution time and the average request/response latency while increasing resource (e.g., compute hardware) utilization. The advanced batching and execution orchestration techniques are referred to herein as GRD functionality, which is based on the definition of a GRD threshold that defines when a set of requests within a specific batch is executing for too long with respect to its peers in that batch. The GRD functionality will stop the batch execution when the greed threshold is reached, and will re-queue the “greedy” requests (e.g., the set of requests within a batch that are still executing when the GRD threshold is reached) in an upcoming batch. By setting the GRD threshold for the last standing requests (e.g., where, if the GRD threshold is reached and any requests within the batch are still executing, such requests are dropped and re-queued in a new batch), the GRD functionality avoids “starving” incoming requests and improving overall resource utilization.

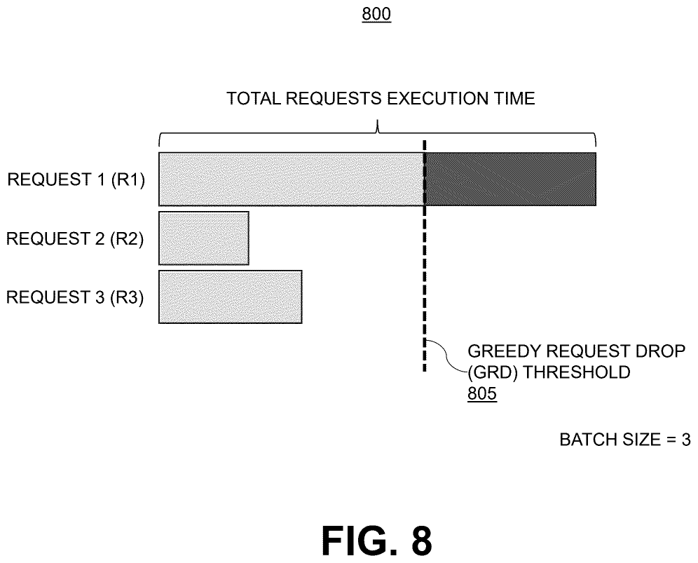

FIG. 8 shows a batch execution flow 800, where the batch size is 3 and includes requests R1, R2 and R3. The batch execution flow 800 includes a GRD threshold 805, which triggers stopping of the batch execution when one of the requests (e.g., R1) has an execution time which is more than a threshold execution time beyond that of the remaining requests (e.g., R2 and R3) in the batch. The “greedy” request R1 will be dropped, and re-queued in a new batch. The new batch will include previously dropped requests with their cached progress, so that the overhead caused by the dropped requests is reduced to a minimum.

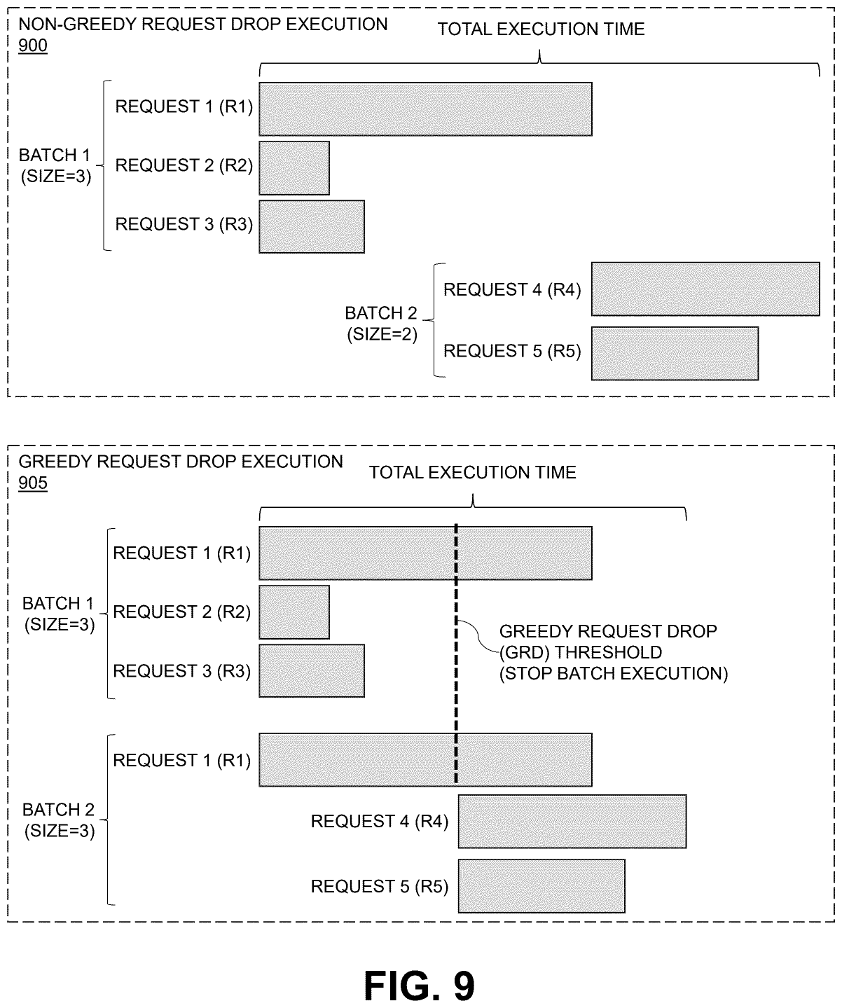

FIG. 9 shows request execution 900 without GRD functionality and request execution 905 with GRD functionality. The request executions 900 and 905 include the same set of five requests R1, R2, R3, R4 and R5. In the request execution 900 without GRD functionality, a first batch of size 3 is executed for requests R1, R2 and R3, followed by a second batch of size 2 for requests R4 and R5. The second batch does not execute until all of the requests in the first batch have finished, including the request R1 which is a “greedy” request that continues executing for a significant period of time after requests R2 and R3 are finished, thus delaying the time at which the second batch (including requests R4 and R5) begins executing. Thus, the total execution time is extended. In the request execution 905 with GRD functionality, the first batch of size 3 stops executing when the GRD threshold is reached, and the greedy request R1 is stopped and re-queued for execution during the second batch (which has size 3). As illustrated in FIG. 9, the total execution time for the request execution 905 with GRD functionality is reduced relative to the request execution 900 without GRD functionality.

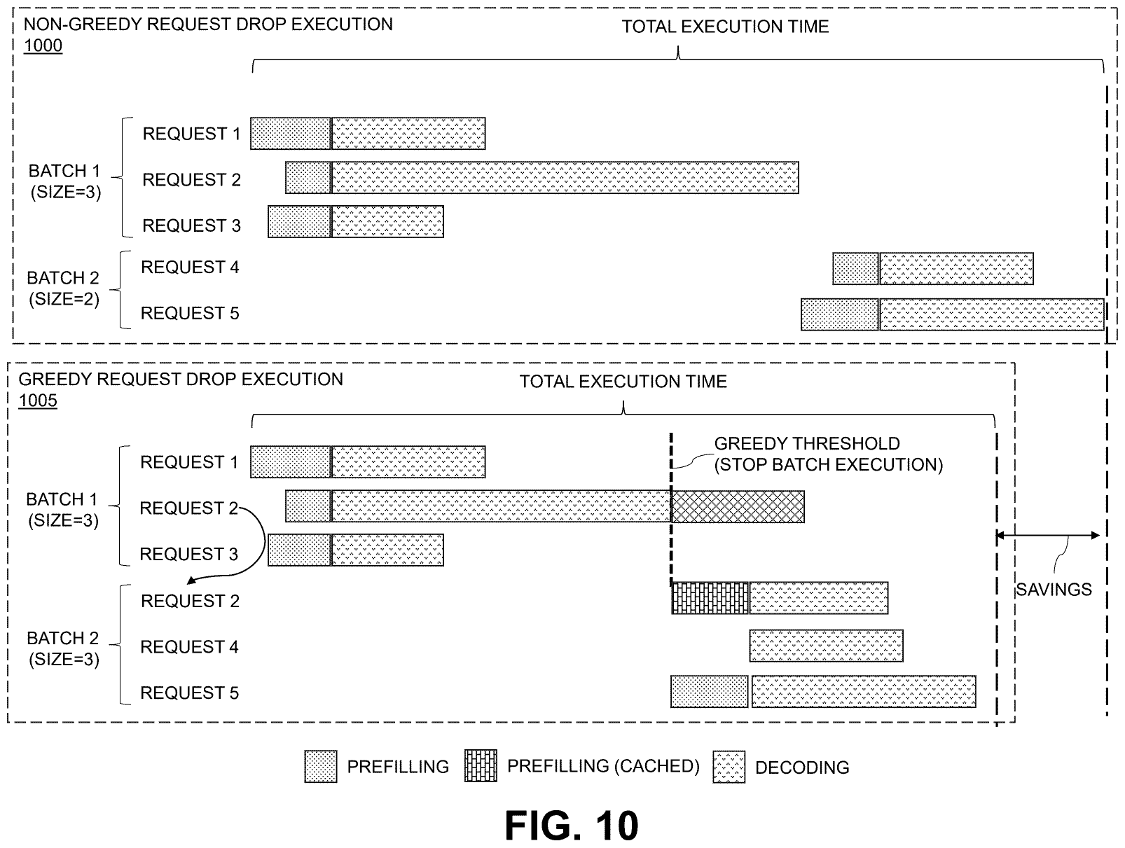

FIG. 10 shows another example of request executions 1000 and 1005, where the request execution 1000 does not utilize GRD functionality and the request execution 1005 does utilize GRD functionality. Again, the request executions 1000 and 1005 include five requests R1, R2, R3, R4 and R5, and a batch size of 3 is utilized. The request execution 1000 without GRD functionality includes, in the first batch, a greedy request R2 that causes the execution of the first batch to be extended. The request execution 1005 with GRD functionality stops the execution of the first batch once the GRD threshold is reached, and the greedy request R2 is stopped and re-queued for execution in the second batch. This provides time and resource savings for the total execution time as illustrated. The GRD threshold, as will be described in further detail below, may be set as a function of the already-completed requests in the first batch (e.g., as a designated threshold time or number of output tokens generated once at least a threshold number of the requests in the batch have completed execution). There is some overhead generated by the re-queueing of greedy requests, though this overhead is small as the prefilling operations are several magnitudes faster than decoding processing per token as discussed above.

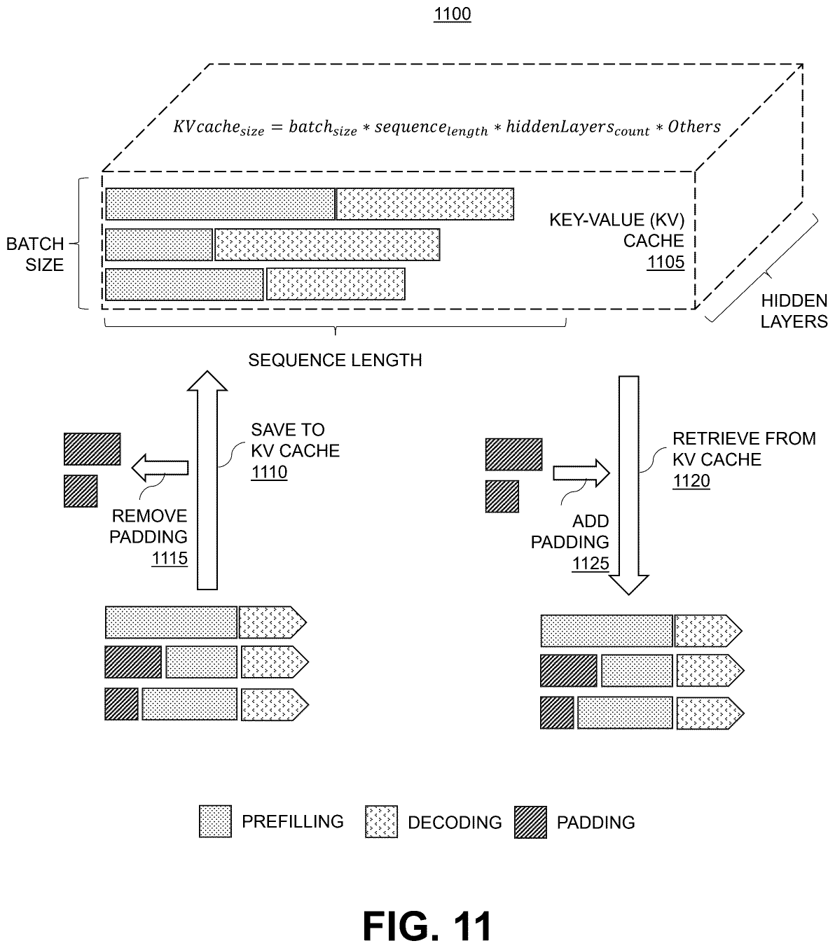

The GRD functionality described herein is compatible with various padding strategies, including left or right alignment padding as illustrated in FIG. 7. The GRD functionality, in some embodiments, provides improved performance by leveraging an advanced padding strategy. The advanced padding strategy may be viewed as a “pad-less” approach, which utilizes an asymmetric pad-less cache that from one side removes the need to store the padding in memory (e.g., in the KV cache) by subtracting the padding before storing it in memory and adding it when the information is retrieved from memory. This approach is illustrated in FIG. 11, which shows an asymmetric pad-less caching system flow 1100, where a KV cache 1105 has a size (KVcache_{size}) that is determined according to the batch size (batch_{size}), sequence length (sequence_{length}) and the number of hidden layers (hiddenLayers_{count}):

$${KVcache}_{size} = {batch}_{size} * {sequence}_{l ength} * {hiddenLayers}_{count} * Others$$

where Others represents a factor for other potential data that is stored in the KV cache, which may vary between different implementations. In some cases, it is expected that the Others factor is negligible and will not significantly impact the size of the KV cache (KVcache_{size}). In other cases, depending on how the LLM and KV cache are implemented, the Others factor may have a more significant impact. When data is saved to the KV cache 1105 in block 1110, padding is removed in block 1115. When data is retrieved from the KV cache 1105 in block 1120, the padding is added in block 1125.

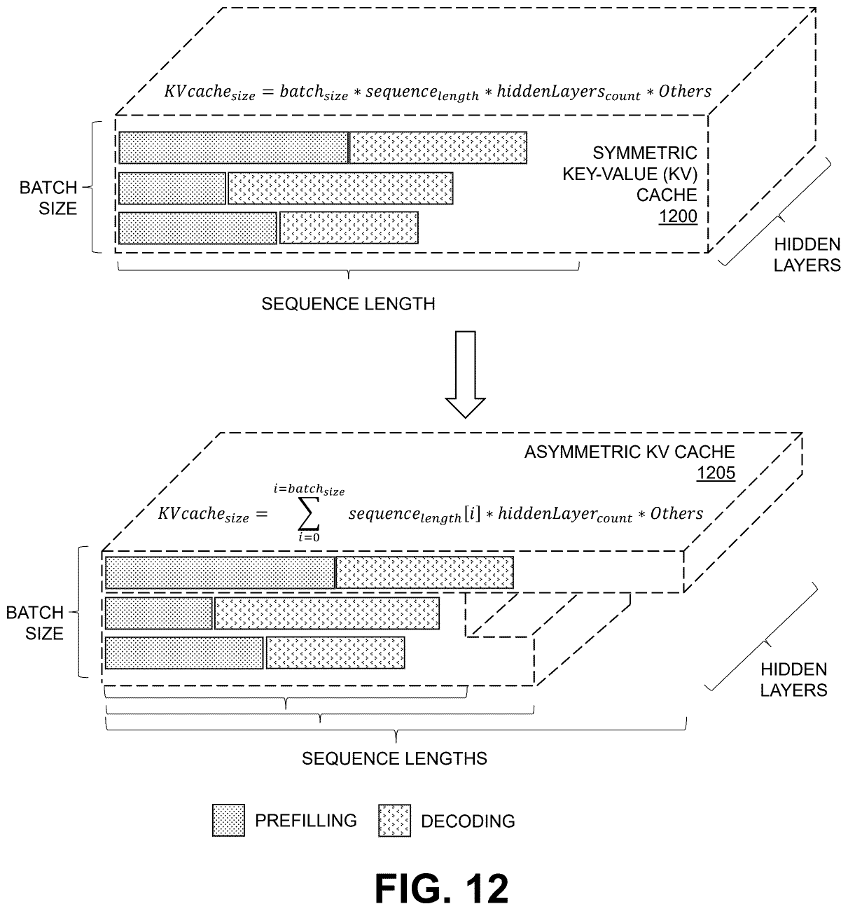

The asymmetric pad-less cache approach further allows for allocating the cache asymmetrically for the requests stored therein, as each request may have a different input size and all the requests in a batch generate tokens at the same pace. This avoids the situation where some requests fill the cache earlier than others. Such asymmetric cache allocation is illustrated in FIG. 12. FIG. 12 shows a symmetric KV cache 1200 and an asymmetric KV cache 1205. The symmetric KV cache 1200 has a size that is determined by the batch size, the sequence length of the longest request in the batch, and the hidden layers as described above with respect to FIG. 11. The asymmetric KV cache 1205, in contrast, allocates the cache size (KVcache_{size}) asymmetrically for the different requests in the batch based on the batch size (batch_{size}), the differing sequence lengths (sequence_{length}[i]), and the number of hidden layers (hiddenLayer_{count}):

$${KVcache}_{size} = {\sum }_{i = 0}^{i = {batch}_{size}} {sequence}_{length} [ i ] * {hiddenLayer}_{c ount} * Others$$

where Others again represents a factor for other potential data that is stored in the KV cache, which may vary between different implementations. The asymmetric KV cache 1205 provides space savings relative to the symmetric KV cache 1200.

Approaches for setting the GRD threshold and associated trigger conditions will now be described. The trigger conditions define the conditions by which a GRD threshold becomes operative. In some embodiments, by default, the trigger condition is when all requests within a batch except one have finished generation (e.g., a token end-of-sentence </s> or end-of-sequence <eos> is returned). Depending on the batch size, the trigger condition may be set as a percentage of requests that have finished. For larger batch sizes, setting the trigger conditions as a percentage of requests that have finished makes more sense. By way of example, for a batch size of 64 and a percentage threshold of 90%, the trigger condition is activated after 57 requests within the batch have finished. In some embodiments, the trigger condition may also or alternatively be based on the number of requests which are queued and waiting for the next batch to begin. If there are no requests waiting to execute, then the GRD threshold may not be used. If there is at least a designated threshold (e.g., X, where X may be based at least in part on the batch size) number of requests waiting to execute, then the trigger condition may be more aggressive.

The GRD threshold defines when a set of requests become “greedy” and thus should be stopped and re-queued. In some embodiments, a static GRD threshold is used. Similar to a global upper limit on a sequence length, a static upper limit may be set that a request cannot surpass on a single execution. In other embodiments, a dynamic GRD threshold is used. With the dynamic GRD threshold, the last lived (e.g., “greedy”) requests get a limited time to finish execution before being dropped. This limited time, however, is not fixed beforehand and is instead computed as a function of the finish time of the other requests in the batch in order to optimize computation resources.

The re-queuing of greedy requests includes dropping a request out of execution in a current batch and adding that request to a future batch to continue its execution. As discussed above, prefilling is generally (subject to the specific LLM configuration) several magnitudes faster to execute than the whole decoding stage. For this reason, when a greedy request is dropped in process, that request can be moved. All the tokens generated before the drop happened can be concatenated as part of its input sequence in a future batch. Thus, when the request is next executed, it can start from the last output token generated during processing in the previous batch and it does not need to compute the whole output sequence again. At the same time, the overhead or extra steps done by dropping the request and executing it again are negligible as prefilling is much faster than decoding.

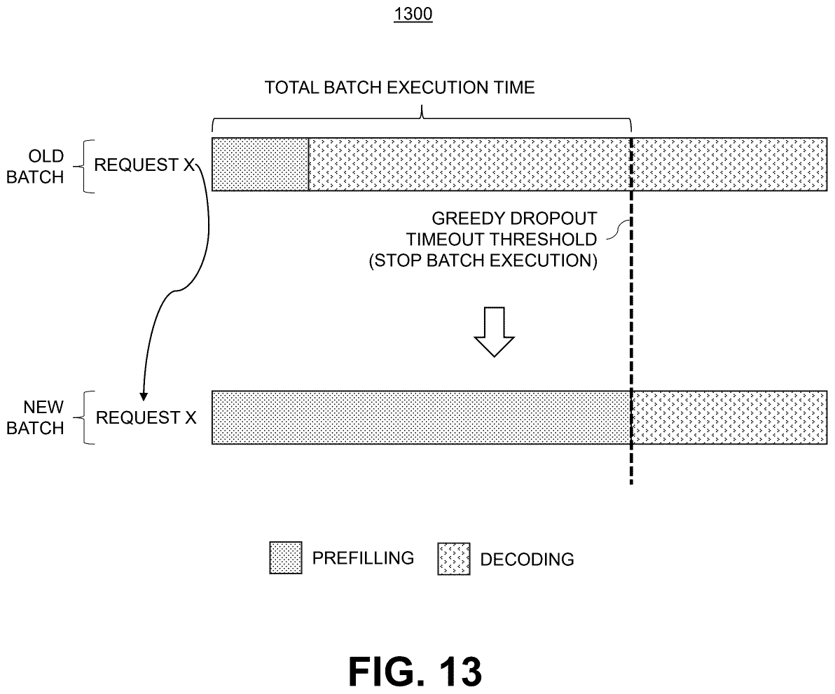

FIG. 13 shows a process flow 1300 for re-queuing a request (e.g., request X), converting an already-executed output from execution of the request X in an old batch as part of the new input when re-queuing the request X in a new batch. Consider, for example, that the request X has an input sequence of 10 tokens and an output sequence of 50 tokens. It should be noted that, in practice, the output sequence length is not known beforehand. If on the first execution of the request X (e.g., in the “old” batch), the GRD threshold is reached after processing the output token number 30, then the next time the request X is executed (e.g., in the “new” batch), the request X can start with an input sequence of 40 tokens (e.g., the original input sequence of 10 tokens concatenated with the 30 tokens output during processing of the request X in the old batch), and only 20 output tokens need to be computed.

Depending on what happens with the memory allocated for the greedy request that is dropped, there are several options for implementing the GRD functionality. In some embodiments, the part of the memory that is associated with the processing of a specific greedy request (e.g., a portion of memory of the KV cache) is copied and that portion of the memory is released. The next batch is then started normally. This will incur some latency due to the need to copy the information out of the memory (e.g., the KV cache) when the current batch is stopped, and to copy the information back into the memory (e.g., the KV cache) for the next batch. In other embodiments, a more efficient option is to hold the dropped request information (e.g., for the greedy requests) in memory (e.g., the KV cache) and reference it back when processing the new batch. This provides a more time efficient approach, though it requires keeping the reference cache segments of the dropped requests. This also makes it more difficult to change the cache dimension shape for future batches (e.g., in the case where a decision is made to change the amount of data cached, the number of requests served in a new batch, etc.).

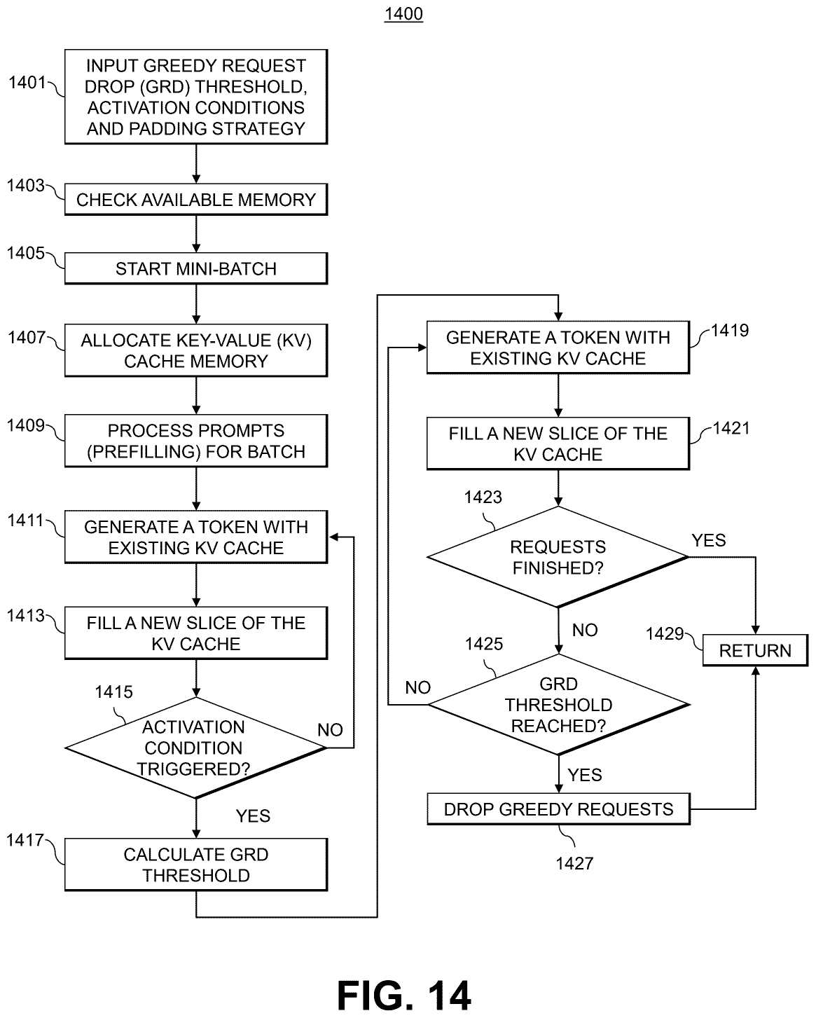

FIG. 14 shows a process flow 1400 for implementing GRD functionality. The process flow 1400 begins in block 1401 with inputting a GRD threshold, activation conditions for the GRD threshold, and a padding strategy to be utilized. This input may be user-defined, default values, etc. In block 1403, available memory is checked. In block 1405, a batch including at least a subset of a set of requests (e.g., for performing LLM or other AI/ML inference) is started. The batch may be referred to as a “mini-batch” as it assumes that the set of requests cannot be processed in a single batch, such that multiple batches will be required for processing. It should be appreciated, however, that this is not a requirement—the entire set of requests may be processed in a single batch, additional requests may be received during processing of a batch, etc. In block 1407, a KV cache is allocated in the memory.

In block 1409, input prompts (e.g., user prompts in an LLM model) are processed for the batch. Such input prompt processing is an example of the prefilling stage of processing. In block 1411, a token is generated with the existing KV cache. The generated token is then filled in a new slice of the KV cache in block 1413. In block 1415, a determination is made as to whether any of the activation conditions specified in block 1401 have been triggered. If the result of the block 1415 determination is no, the process flow 1400 returns to block 1411. If the result of the block 1415 determination is yes, then a GRD threshold is calculated in block 1417.

In block 1419, a token is generated with the existing KV cache. A new slice of the KV cache is then filled in block 1421 (e.g., with the token generated in block 1419). In block 1423, a determination is made as to whether the requests in the batch have finished processing. If the result of the block 1423 determination is no, then the process flow 1400 continues to block 1425 where a determination is made as to whether the GRD threshold has been reached. If the result of the block 1425 determination is no, the process flow 1400 returns to block 1419. If the result of the block 1425 determination is yes, the process flow 1400 proceeds to block 1427 where “greedy” requests (e.g., any requests still processing after the GRD threshold is reached) in the batch are dropped. The results of the batch are then returned in block 1429. The results of the batch are also returned in block 1429 if the result of the block 1423 determination is yes.

The technical solutions described herein provide GRD functionality which optimizes batch inference for AI/ML model processing (e.g., LLM inference) to improve serving latency and resource utilization. The technical solutions are thus able to provide significant improvements related to the time required for performing AI/ML model inference, resource utilization for performing AI/ML model inference, etc.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for request batch processing for machine learning models will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that may be utilized to implement at least a portion of the information processing system 100 in FIG. 1. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 may comprise respective VMs, respective sets of one or more containers, or respective sets of one or more containers running in VMs.

In some implementations of the FIG. 15 embodiment, the VMs/container sets 1502 comprise respective VMs implemented using virtualization infrastructure 1504 that comprises at least one hypervisor. A hypervisor platform may be used to implement a hypervisor within the virtualization infrastructure 1504, where the hypervisor platform has an associated virtual infrastructure management system. The underlying physical machines may comprise one or more distributed processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1602-1 in the processing platform 1600 comprises a processor 1610 coupled to a memory 1612.

The processor 1610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1612 may comprise random access memory (RAM), read-only memory (ROM), flash memory or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for request batch processing for machine learning models as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to execute, in a first batch, a first set of requests utilizing at least one machine learning model;
to determine, during execution of the first batch, whether one or more request drop activation conditions are triggered;
responsive to determining that at least one of the one or more request drop activation conditions has been triggered, to establish a request drop threshold for stopping execution of the first batch;
to determine whether any of the requests in the first set of requests are still executing when the request drop threshold is reached;
responsive to determining that at least a subset of the first set of requests is still executing when the request drop threshold is reached, to stop execution of the first batch; and
to execute, in a second batch, a second set of requests utilizing the at least one machine learning model, the second set of requests including at least one request in the subset of the first set of requests.

2. The apparatus of claim 1 wherein the at least one machine learning model comprises a large language model.

3. The apparatus of claim 1 wherein the one or more request drop activation conditions comprises determining that at least a threshold number of requests in the first set of requests has finished execution.

4. The apparatus of claim 3 wherein the threshold number comprises a designated percentage of a total number of requests in the first set of requests.

5. The apparatus of claim 1 wherein the one or more request drop activation conditions is based at least in part on a number of requests waiting to be executed utilizing the at least one machine learning model.

6. The apparatus of claim 1 wherein the request drop threshold comprises a specified period of time.

7. The apparatus of claim 1 wherein the request drop threshold comprises a specified number of output tokens generated utilizing the at least one machine learning model.

8. The apparatus of claim 1 wherein the request drop threshold specifies a static upper limit for execution time of requests in the first set of requests.

9. The apparatus of claim 1 wherein the request drop threshold specifies a dynamic upper limit for execution time of requests in the first set of requests that is based at least in part on an execution time for completed requests in the first set of requests.

10. The apparatus of claim 1 wherein each of the requests in the first set of requests comprises:
a prefilling stage where an input prompt is tokenized and processed to fill activation tensors of one or more layers of the machine learning model; and
a decoding stage where in each pass a new token is generated and appended to the input prompt for processing in a next pass.

11. The apparatus of claim 10 wherein:
stopping execution of the subset of the first set of requests comprises, for said at least one request in the subset of the first set of requests, concatenating the new tokens generated in the decoding stage with the tokenized input prompt to generate an updated tokenized input prompt; and
executing the at least one request in the subset of the first set of requests in the second batch utilizes the updated tokenized input prompt in the prefilling stage.

12. The apparatus of claim 1 wherein executing the at least one request in the subset of the first set of requests in the second batch starts from a last output token generated during execution of the at least one request during the first batch.

13. The apparatus of claim 1 wherein executing the first batch comprises allocating a portion of memory for a symmetrical cache for maintaining input and output tokens generated as part of processing the first set of requests, the symmetrical cache having a size determined based at least in part on a number of requests in the first set of requests, a maximum sequence length for the first set of requests, and a number of hidden layers of the at least one machine learning model.

14. The apparatus of claim 1 wherein executing the first batch comprises allocating a portion of memory for an asymmetrical cache for maintaining input and output tokens generated as part of processing the first set of requests, the asymmetrical cache having a size determined based at least in part on a number of requests in the first set of requests, sequence lengths of different ones of the requests in the first set of requests, and a number of hidden layers of the at least one machine learning model.

15. A computer program product comprising a non-transitory processor-readable storage medium having stored therein program code of one or more software programs, wherein the program code when executed by at least one processing device causes the at least one processing device:
to execute, in a first batch, a first set of requests utilizing at least one machine learning model;
to determine, during execution of the first batch, whether one or more request drop activation conditions are triggered;
responsive to determining that at least one of the one or more request drop activation conditions has been triggered, to establish a request drop threshold for stopping execution of the first batch;
to determine whether any of the requests in the first set of requests are still executing when the request drop threshold is reached;
responsive to determining that at least a subset of the first set of requests are still executing when the request drop threshold is reached, to stop execution of the first batch; and
to execute, in a second batch, a second set of requests utilizing the at least one machine learning model, the second set of requests including at least one request in the subset of the first set of requests.

16. The computer program product of claim 15 wherein the one or more request drop activation conditions comprises determining that at least a threshold number of requests in the first set of requests has finished execution.

17. The computer program product of claim 15 wherein executing the at least one request in the subset of the first set of requests in the second batch starts from a last output token generated during execution of the at least one request during the first batch.

18. A method comprising:
executing, in a first batch, a first set of requests utilizing at least one machine learning model;
determining, during execution of the first batch, whether one or more request drop activation conditions are triggered;
responsive to determining that at least one of the one or more request drop activation conditions has been triggered, establishing a request drop threshold for stopping execution of the first batch;
determining whether any of the requests in the first set of requests are still executing when the request drop threshold is reached;
responsive to determining that at least a subset of the first set of requests is still executing when the request drop threshold is reached, stopping execution of the first batch; and
executing, in a second batch, a second set of requests utilizing the at least one machine learning model, the second set of requests including at least one request in the subset of the first set of requests;
wherein the method is performed by at least one processing device comprising a processor coupled to a memory.

19. The method of claim 18 wherein the one or more request drop activation conditions comprises determining that at least a threshold number of requests in the first set of requests has finished execution.

20. The method of claim 18 wherein executing the at least one request in the subset of the first set of requests in the second batch starts from a last output token generated during execution of the at least one request during the first batch.
